(19) United States
(12) Patent Application Publication
(10) Pub. No.: US 2026/0231257 A1
(43) Pub. Date: Aug. 6, 2026

(54) METHOD AND APPARATUS FOR USING SIDELINK TO SUPPORT ARTIFICIAL INTELLIGENCE OR MACHINE LEARNING OPERATIONS

(71) Applicant: Samsung Electronics Co., Ltd., Suwon-si, Gyeonggi-do (KR)

(72) Inventors: Morteza KHEIRKHAH, Staines, Middlesex (GB); Mahmoud WATFA, Staines, Middlesex (GB); Chadi KHIRALLAH, Staines, Middlesex (GB); David Gutierrez ESTEVEZ, Staines, Middlesex (GB); Daniel WARREN, Staines, Middlesex (GB)

(21) Appl. No.: 19/154,745

(22) PCT Filed: Feb. 6, 2024
(86) PCT No.: PCT/KR2024/001719

§ 371 Date: Aug. 7, 2025

(30) Foreign Application Priority Data
Feb. 7, 2023 (GB) 2301728.8
Dec. 21, 2023 (GB) 2319815.3

(51) Int. Cl. H04W 76/14; H04W 8/24; H04W 76/30

(52) U.S. Cl. CPC H04W 76/14; H04W 8/24; H04W 76/30

(57) ABSTRACT

This invention relates to a method of routing data traffic in a telecommunication system, the system comprising a network and a plurality of UEs, wherein a first of the plurality of UEs is connected to the network and a second of the plurality of UEs is connected to the first UE via a direct connection and is thereby able to route traffic to the network via the first UE.

### TECHNICAL FIELD

The present invention relates to improvements in a telecommunication network to allow User Equipments (UEs) to continue to provide data related to Artificial Intelligence (AI) or Machine Learning (ML) applications.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### DISCLOSURE OF INVENTION

### Technical Problem

In line with development of the communication systems, there is a need for method and apparatus for using sidelink to support artificial intelligence or machine learning operations.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

Disclosed is a method of routing data traffic in a telecommunication system, the system comprising a network and a plurality of User Equipments, UEs, wherein a first of the plurality of UEs is connected directly to the network and a second of the plurality of UEs is connected to the first UE via a direct connection and is thereby able to route traffic to the network via the first UE.

### Advantageous Effects of Invention

The present disclosure provides an effective and efficient method for supporting artificial intelligence or machine learning operations. Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

FIG. 1 shows a schematic of Federated Learning (FL) Interactions;

FIG. 2 shows a table of latency associated with FL data transfer;

FIG. 3 shows Sync-FL interactions;

FIG. 4 shows a Hierarchical FL model;

FIG. 5 shows a ProSe Discovery method (Model A);

FIG. 6 shows a ProSe Discovery method (Model B);

FIG. 7 shows a UE state machine; and

FIG. 8 shows a call flow according to an embodiment of the invention.

### MODE FOR THE INVENTION

Federated Learning (FL) is an important machine learning technique that allows a set of participants or User Equipments (UEs) to engage in distributed model training without exposing their own parameters (data) other than a set of weights to outside entities. It is predicted that FL will be significantly used in several 5G/6G use cases and thus, it generates a significant amount of traffic on 5G/6G networks. Therefore, it is important that this is managed carefully within 3GPP networks.

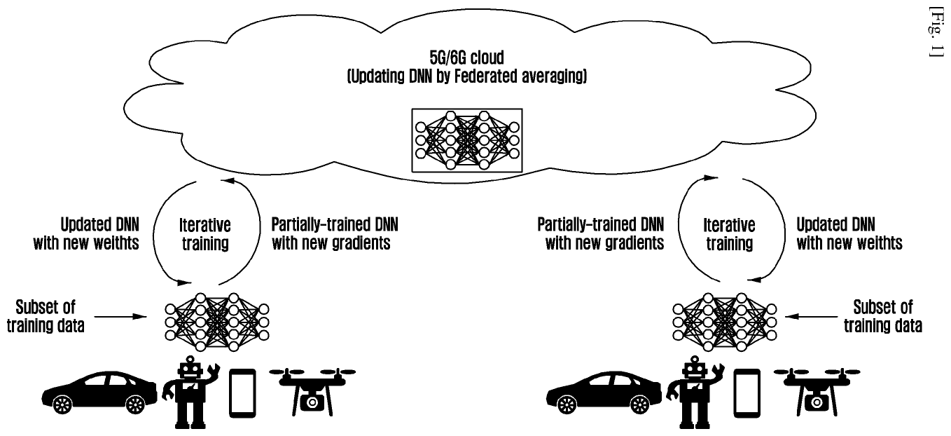

FIG. 1 shows certain key interactions between the main entities involved in a distributed FL model training session. Participants can be e.g. a car, robot, smartphone, or drone and the central FL server may be located in a 5G/6G cloud within or outside the 3GPP network. Note that a central FL server may be located in other locations such as Radio Access Network (RAN), 5GC and/or UE, especially in a hierarchical FL model.

A general working principle of FL model training is as follows:
Participants advertise their willingness to be part of a training session.
The FL server selects a set of participants to be part of the next training cycle based on a set of criteria that may be dynamically changed between training cycles.
The FL server then distributes the latest trained global model to selected participants.
Each participant then starts its local model training when it receives the global model and its related configurations. The local training may use a particular or locally available dataset or real environment parameters.
Each participant then sends the trained model to the FL server once its local training is completed (i.e., when the local model is converged and is stable).
The FL server then aggregates all locally trained models from participants, creating a new global model which can be further distributed between participants in the next round of training sessions.

Synchronous Federated Learning (Sync-FL) is another form of FL where participants have a strict deadline for their local model training completion and also uploading the results to the central FL server. If a participant can't meet the deadline, its results (i.e., trained models) may be unused by the central FL server, wasting 3GPP resources across UE, RAN, and Core Network (CN). On that basis, typically, the central FL server indicates these time constraints to participants so that the compute and network resources can be adjusted accordingly. That said, completing local model training at UE is also computationally intensive and thus requires a significant amount of power which is a crucial resource, especially for mobile devices with limited battery capacity.

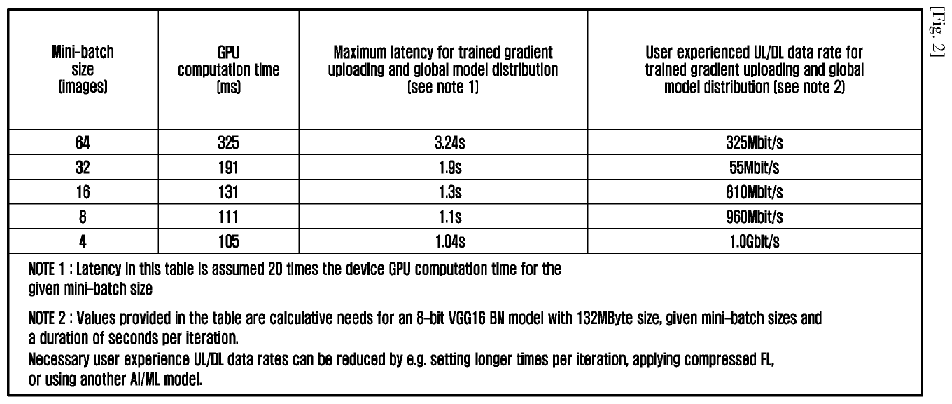

The Table in FIG. 2 shows Latency and user experienced Uplink/Downlink (UL/DL) data rates for uncompressed FL.

Synchronous Federated Learning (Sync-FL) is sometimes vulnerable to unpredicted wireless condition and the divergence of UEs' capabilities. Therefore, the Asynchronous FL, (Async-FL), has been widely used in many circumstances. The main idea of Async-FL is to let a UE report its result whenever it is ready, and the FL server will refresh the global model without waiting for all intermediate results to be collected from all participants. The Sync-FL is very useful in the case of collaborative devices using the Sidelink interface where a UE can exchange a training model with another UE in its proximity and/or it can relay the training results indirectly to the central FL server via a relay UE.

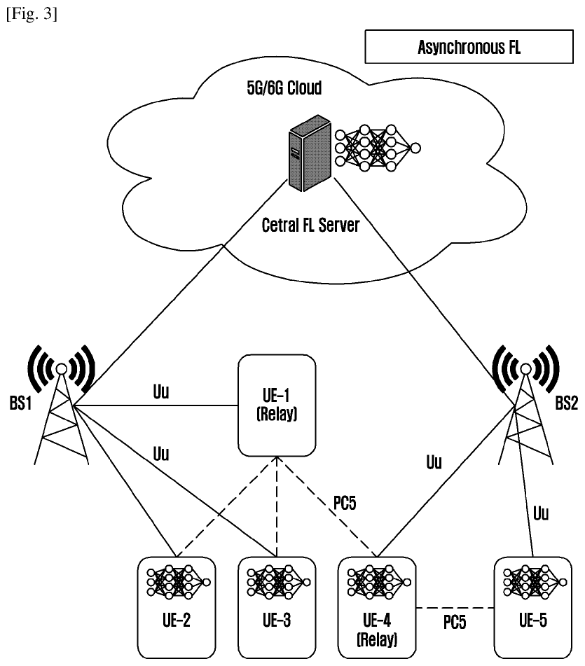

FIG. 3 shows a scenario where a cluster of UEs (UE-2 to UE-4) with bad cellular coverage are connected to the central FL server indirectly via UE-1. The connectivity of member UEs in this cluster to UE-1 could be established by any link technology (Sidelink, Cellular, WLAN, Fiber, Ethernet, etc.). However, in this figure, it is assumed to be cellular over the Uu interface and/or Sidelink over the PC5 interface. Under such scenarios, UEs connected to UE-1 (i.e., Relay UE) may have an active but poor cellular connection. Note that UE-4 can also act as a Relay UE for UE-5, permitting UE-5 to access the main central FL server indirectly.

UEs can discover each other via the Proximity-Based Service (ProSe) provided by the 3GPP system based on the location of UEs to one another. For example, UE-1 may announce to other UEs that it can be a Relay UE for them. Alternatively, FL member UEs can discover that UE-1 is a Relay UE and then initiate a direct connection over the PC5 interface to UE-1.

Note that, in this particular scenario, there are several reasons that a UE may connect to another UE nearby over a Sidelink connection, such as user mobility, poor/intermittent cellular connectivity, accessing particular information available at a nearby device such as particular training datasets, using a particular capability of the nearby devices such as GPUs/CPUs, offloading computations, lack of power to maintain the cellular connectivity, etc.

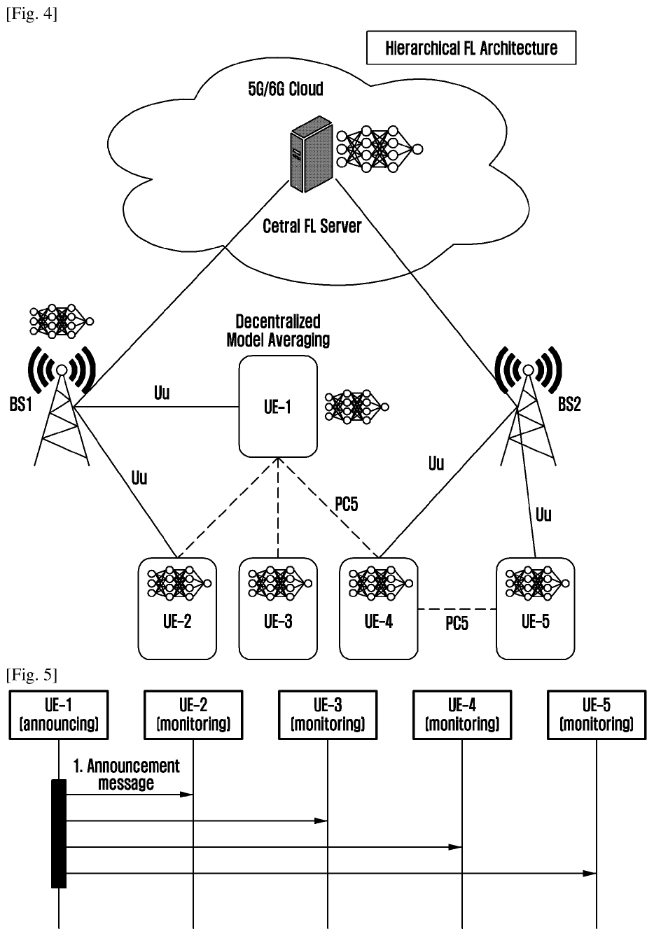

With the hierarchical FL model, UE-1 in FIG. 4 is capable of “decentralized model averaging” in which the member UEs in its proximity (i.e., UE-2, UE-3, and UE-4) can only interact with UE-1 to share their locally trained model and get an updated global model to continue with FL training cycles. In other words, UE-1 acts similarly to the central FL server and also does not relay any traffic from member UEs (i.e., UE-2-4) to the central FL server. UE-1 is one of the participants in a distributed FL training with the capability of decentralized model averaging. UE-1 regularly exchanges its locally trained model (which is the aggregate of other UE's training results) with the central FL server and gets an updated global model. A note should be taken that UE-1 can only interact and exchange training models with a server located at RAN while that the RAN server directly interact with the central FL server hosted in the 5G/6G cloud or elsewhere.

Under such scenarios, UE-4 may also be capable of “decentralized model averaging” so it can handle UE-5, permitting UE-5 to continue its model training without needing to interact directly with an FL server higher in the hierarchy. This way, more participants can join in a distributed model training, although they may not have an active cellular connection.

Like Async-FL, UEs can discover one another via the Proximity-Based Service (ProSe) provided by the 3GPP system based on the location of UEs to each other.

There are two ProSe direct discovery procedures over PC5 reference point standardized in the 3GPP system: Model A and Model B.

Model A is illustrated in FIG. 5 and uses a single discovery protocol message (Announcement) where the announcer UE (i.e., UE-1 in FIG. 5) broadcasts an announcement message to UEs in its proximity. The Announcement message may include the Type of Discovery Message, ProSe Application Code or ProSe Restricted Code, security protection element, metadata information, etc. The Application layer metadata information may be included as metadata in the Announcement message.

UEs in proximity receive the announcement message. The announcing UE could be an FL-capable UE with good connectivity to the central FL server (e.g., UE-1 in FIG. 3) which is capable of relaying traffic while other UEs could be UEs with bad coverage in FIG. 3.

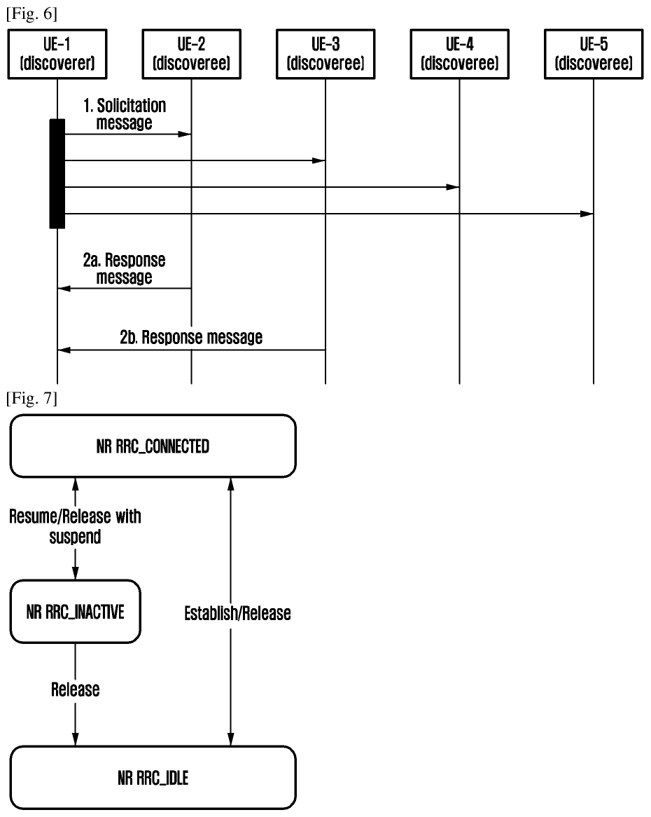

Model B is illustrated in FIG. 6. Here, the Discoverer UE sends a Solicitation message. The Solicitation message may include Type of Discovery Message, ProSe Query Code, security protection element. The Discoveree UE listens to particular Layer-2 ID to get the Solicitation message. The Discoveree UE that matches the solicitation message responds to the Discoverer UE with the Response message. The Response message may include Type of Discovery Message, ProSe Response Code, security protection element, metadata information. The Application layer metadata information may be included as metadata in the Response message.

New Radio (NR) has three Radio Resource Control (RRC) states as follows:
RRC_CONNECTED
RRC_INACTIVE
RRC_IDLE

In RRC_CONNECTED, the UE is fully connected to the network with established Signaling Radio Bearers (SRBs) and Data Radio Bearers (DRBs). When UE is in this state, both RAN and CN have allocated the required resources for this UE to be fully connected, which includes maintaining the UE's context. Having the UE in this state is extremely non-energy efficient. For this reason, when the UE is inactive for a certain predefined period of time, the network may change the UE's RRC state to either RRC_INACTIVE or RRC_IDLE.

When a UE enters RRC_INACTIVE, its established DRBs will be released, so there would not be any established Protocol Data Unit (PDU) sessions to the CN (i.e., no user plane availability between UE and CN). However, SRBs are intact so that UE can still exchange control plane messages with the NG-RAN and CN. Note that in RRC_INACTIVE, the connectivity between NG-RAN and CN is available.

The key motivation to provide the RRC_INACTIVE state in NR is to save energy for the UE while at the same time permitting the UE to return back to the RRC_CONNECTED state with a small number of signalling messages (and thus with low latency). This way, not only can the UE enter this state more frequently to save more power but also can return back to a fully CONNECTED state with established DRBs setup quickly, which is essential for low latency applications.

In RRC_INACTIVE, the UE can still send small amounts of user plane data to the network over established SRBs via the 3GPP Small Data Transmission (SDT) technology, which has been standardized for Cellular Internet of Things (IOT) use cases. These IoT devices are typically equipped with low battery capacity, and they typically require sending small amounts of data to the network infrequently.

When the UE is in RRC_IDLE, it is disconnected from the network, and thus no resources are allocated for the UE in the RAN and CN. Returning back from RRC_IDLE to RRC_CONNECTED requires several signalling messages to be exchanged between UE, RAN, and CN (e.g., re-establishing security, establishing SRBs and DRBs, UE initial context setup, etc.). Entering RRC_IDLE is not well suited for latency-sensitive applications that may require transmitting user plane data to the network with low UL transmission delay. That said, utilizing this state effectively may optimize a significant amount of resources across the 3GPP system, including UE, RAN, and CN.

FIG. 7 highlights RRC state machine and state transition in NR. The RRC_INACTIVE is new in NR and it is a middle state between RRC_CONNECTED and RRC_IDLE.

FL participants must be able to complete and deliver their local model training to the central FL server in an acceptable time window. In some cases, this may become challenging when the UE has a low battery capacity or it is predicted that UE will be in a low battery status soon. This condition worsens as the UE uses Sidelink while also maintaining its cellular connectivity over the Uu reference point.

Cellular connectivity consumes significant energy due to procedures such as Radio Link Monitoring (RLM), measurement and measurement reporting messages, PDCCH for UL/DL scheduling, etc. In other words, from a power consumption perspective, keeping the UE in the RRC CONNECTED state is highly inefficient if not needed, which may be the case when connected to another UE over a direct Device to Device (D2D) connection.

It is an aim of embodiments of the present invention to intelligently optimize power consumption for UEs willing to use Sidelink to continue in FL distributed model training. It is an aim to also be of use in other cases of collaborative devices (e.g., V2X, XR, etc.).

To further specify aims of embodiments, it is to be determined if it is desirable to allow network entities (e.g., NG-RAN/gNB and/or CN, other) and/or network functions to assist a UE (or a group of UEs) in determining whether a Sidelink connection is needed, either to support AI/ML operations or optimizing network resources, especially at RAN side.

Further, it is to be determined if network entities (e.g., NG-RAN/gNB and/or CN, other) and/or network functions can assist a UE (a group of UEs) in establishing a direct D2D connection to another UE in its proximity over PC5 to support AI/ML operations.

Further, it is to be determined if network entities (e.g., NG-RAN/gNB and/or CN, other) and/or network functions can assist a UE (or a group of UEs) in optimizing its energy consumption so that an AI/ML operation (at the UE-side and/or network-side) will not be disturbed/impacted by a potential lack of power.

According to the present invention there is provided an apparatus and method as set forth in the appended claims. Other features of the invention will be apparent from the dependent claims, and the description which follows.

According to a first aspect of the present invention, there is provided a method of routing data traffic in a telecommunication system, the system comprising a network and a plurality of User Equipments, UEs, wherein a first of the plurality of UEs is connected directly to the network and a second of the plurality of UEs is connected to the first UE via a direct connection and is thereby able to route traffic to the network via the first UE.

In an embodiment, a decision to route traffic directly from the second UE to the first UE is taken either by the network which then instructs the second UE or is due to a preconfigured policy in the second UE.

In an embodiment, the reason to route traffic directly from the second UE to the first UE is based on one or more of: battery life at the second UE; connectivity of the second UE with respect to the telecommunication network; processor load of the second UE; available memory in the second UE; and availability of resources in the second UE

In an embodiment, only a certain class of data traffic is routed directly from the second UE to the first UE.

In an embodiment, the certain class of data traffic is related to Artificial Intelligence, Machine Learning or Federated Learning.

In an embodiment, wherein the second UE is configured to share state information with the network to facilitate routing decisions.

In an embodiment, the network provides assistance information to one or more of the plurality of UEs to initiate a direct connection therebetween.

In an embodiment, the assistance information provided by the network is configured to assist one of the plurality of UEs to determine which other of the plurality of UEs it should directly connect to.

In an embodiment, a further step is provided of the second UE entering a low power mode after establishing a direct connection with the first UE.

In an embodiment, the low power mode is one of RRC_INACTIVE or RRC_IDLE state

In an embodiment, the network is a 5G network or NG-RAN.

In an embodiment, the direct connection between the second and first UE is achieved via PC5.

According to a second aspect of the present invention, there is provided apparatus arranged to perform the method of the first aspect.

Embodiments of the invention provide means to facilitate at least one of the following:
NG-RAN/gNB determines to move AI/ML traffic of a UE from its cellular link (i.e., Uu) to Sidelink (i.e., PC5) due to potential shortage of UE's battery
NG-RAN/gNB configures a UE to share its state information with NW to support AI/ML workflows
NG-RAN/gNB signals the status reporting configuration to a UE and also receive a status reporting from a UE to support AI/ML operations
Ways in which NG-RAN/gNB gets more data/analytics about UE's status from 5GC
How 3GPP entities (i.e., UE, RAN, or CN) can assist to signal a UE to initiate a ProSe discovery procedure to support AI/ML operations
How 3GPP entities (i.e., UE, RAN, or CN) can assist a remote UE in selecting a nearby AI/ML-capable UE among multiple candidates after a ProSe discovery is completed
How 3GPP entities (i.e., UE, RAN, or CN) can assist a UE to enter low power mode
NG-RAN/gNB determines to move AI/ML traffic of a UE from its cellular link to Sidelink due to high load at BS
How NG-RAN/gNB can know that a flow is eligible to be moved from the cellular link when BS is highly loaded
UE is configured to offload its AI/ML operation to another UE via PC5 due to low UE power, low UE memory, low UE resources
UE decides on using Sidelink and/or entering into power saving mode according to the cellular connection quality

Although a few preferred embodiments of the present invention have been shown and described, it will be appreciated by those skilled in the art that various changes and modifications might be made without departing from the scope of the invention, as defined in the appended claims.

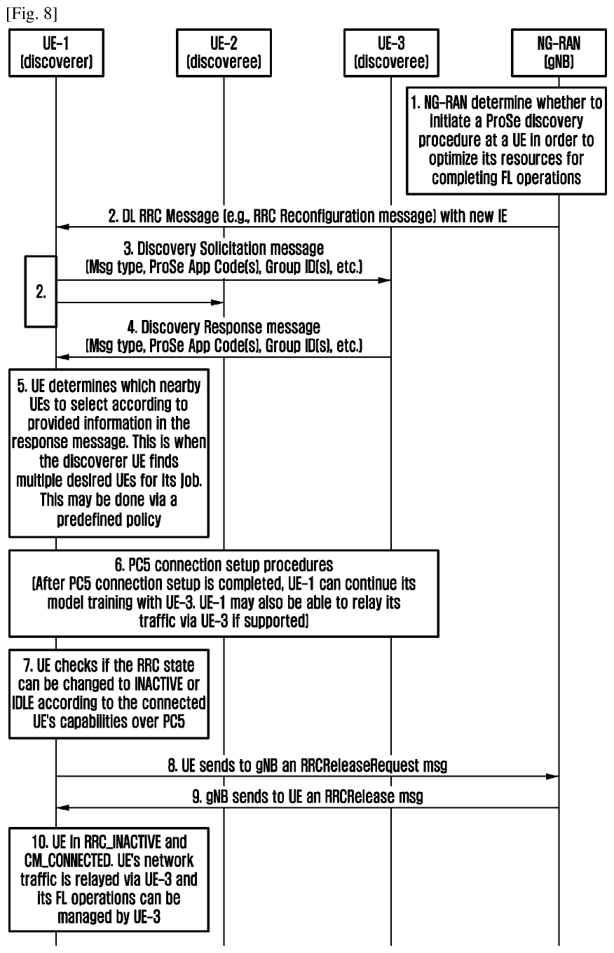

FIG. 8 shows a call flow according to an embodiment of the invention.

In the following description, various assumptions are made:
UE supports direct D2D connectivity over the PC5 reference point.
UE may support other Radio Access Technologies (RATs) for D2D connection such as WLAN and Bluetooth, etc.
UE supports FL operations such as local model training, decentralised model averaging, member selection (i.e., participant selection), etc.
UE supports RRC's INACTIVE state. This information can be signalled to the network via the UE Capability Information message, or an RRC message that UE sends to network expressing all its capabilities.
UE may be able to exchange data and analytics over NAS signalling
UE may be able to exchange data and analytics exchange via AF (e.g., DCAF)

In one embodiment, the UE (e.g. a remote UE) connects to another UE (e.g. nearby) over the PC5 reference point, if supported, in order to continue its (ongoing) AI/ML operations (e.g., FL model training session(s)).

In one embodiment, the UE decision (or behaviour) to connect to another UE (e.g.

nearby), over a PC5 reference point is configured by the network (e.g. NG-RAN and/or CN), or such policy may be locally preconfigured in the UE. Alternatively, the UE's Route Selection Policy (URSP) rules may contain policies such that data for AI/ML (and/or federated learning (FL), etc, where other sub-types may be defined) should be exchanged via the PC5 reference link. Alternatively, the application layer may send application layer signaling to the UE to provide policies or preferences with respect to the type of communication link to use e.g. PC5, based on the type of data for FL, the group of UEs that are involved, the UE locations, etc.

The UE may also be configured with at least one Relay Service Code (RSC) that is specific for AI/ML. As such, when the UE performs discovery of an RSC which corresponds to AI/ML traffic, then the UE (in question i.e. the discoverer UE) may use the discovered UE (e.g. based on the RSC) as the target for PC5 connection and hence exchange (e.g. transmission and/or reception) of data that is specific to AI/ML e.g. for FL.

Alternatively, the UE may be part of a group of UEs which participate in FL and the UE may use group member discovery (which is part of the ProSe feature e.g. see 3GPP TS 23.304) to discover other UEs with which FL can be performed over the PC5 link. The UE may be configured with a specific set of (application layer) group ID, source layer-2 ID, or destination layer-2 ID for FL.

The UE may be configured with policies to use unicast mode or groupcast mode over PC5. For example, a relay UE may be configured to use groupcast mode to share the same training data with a group of UEs over the PC5 link. At any given time, the UE may apply the communication and/discovery mode based on its local policies or configurations.

In one embodiment, the UE may reject the network decision (or instruction) to connect to another UE to complete (or continue) an AI/ML operation (e.g., training session). In one example, the UE may terminate the AI/ML operation (e.g., training session), for example, to save battery. This AI/ML operation termination can also be a signal to AI/ML AF/AS. In one example, the UE informs the network of its rejection to connect to another UE. The UE may provide a new cause value for this rejection.

In one embodiment, the UE may fail to connect to another UE over the PC5 reference point to complete its AI/ML operation. In one example, the UE may terminate the AI/ML operation. In another example, the UE informs the network of the failure to connect to another UE. Optionally, the UE may provide a new cause value for the failure to connect to another UE.

In one embodiment, the network may provide assistance information to a given UE, for example, a list of UEs and other related information, that the UE can use to select from to connect to over PC5 reference point to continue (or complete) its AI/ML operation(s).

In one example, the nearby UE may be AI/ML-capable and/or supports a ProSe relaying technology (e.g., UE-to-Network Relay or UE-to-UE Relay).

In one example, the UE (e.g. remote UE) requests the NG-RAN (or g Node B, gNB) to configure its Uu's RRC state to RRC_INACTIVE. That is, the UE requests the NG-RAN (or gNB) to move this UE to RRC_INACTIVE in order to save battery if needed. Additionally, in one example, the NG-RAN (or gNB) may keep this UE connected to another UE nearby via Sidelink.

There are several other conditions where the network (NW) may instruct the UE (or a group of UEs) to switch its AI/ML operations to another UE (or a group of UEs) in its proximity. For example, when a UE's connectivity/access is intermittent and/or NG-RAN (or gNB) has resource pressure (or limited resources) for DL/UL due to high load scenario, a cluster of UEs (e.g. close-by) can collaboratively (locally) complete AI/ML operations instead of individually interacting with a central AI/ML server, a UE has low battery power, etc.

In one embodiment, the UE may be configured, e.g. due to low UE power, low UE memory, low UE resources (which may include reduced coverage), to offload or delegate its AI/ML operation (e.g. training) to another UE via PC5 link.

In an embodiment, the NG-RAN/gNB determines to move AI/ML traffic of a UE from its cellular link to Sidelink due to lack of battery at UE. In this scenario, the remote UE lacks enough battery power to complete an AI/ML training session, and this shortage has been detected/predicted during a training session. The predictions may be determined by the NW (e.g., NG-RAN). Under such conditions, the remote UE can be instructed by the NW to offload its computations/operations (e.g., local model training) to another AI/ML-capable UE in its proximity. This way, the remote UE will save a significant amount of battery, assuming that processing tasks consume the most power.

In this case, the remote UE may need to deliver required configurations/files regarding AI/ML training to the nearby UE, including model configuration and/or model topology and/or part of a training dataset, etc. If an AI/ML-capable UE nearby is already part of a training session, it does not need to get some of these configurations/files from the remote UE.

In an embodiment, the NG-RAN/gNB configures a UE to share its state information with NW to support AI/ML workflows. In this scenario, the NG-RAN (gNB) selects a UE (or a group of UEs) based on certain requirements and resources capability/availability at the selected UE. In one example, the NG-RAN knowledge of these requirements (and/or any information related to the selection of a UE or a group of UEs) may be obtained from another network entity (e.g. CN) and/or functions, server, and/or application or from UEs directly.

In this case, a UE may be configured by NW (e.g., NG-RAN, gNB, or 5GC) to regularly provide some feedback to NG-RAN (or gNB) regarding its states (e.g., battery status, power consumption rate, heating status, AI/ML application layer-specific feedback, etc.), which is hereafter referred to as status reporting or providing a status report.

In a related embodiment, a UE may be configured by NG-RAN (or gNB) to send the status reporting to NW in different ways, for example, periodically (every X ms after reception of the status reporting configuration), event-based (e.g., when the battery status is lower than a certain threshold), time-based (e.g., 5 secs after reception of the status reporting configuration).

In a related embodiment, the NG-RAN (or gNB) may send the status reporting con-figuration to UE in form of a bit-map scheme (i.e., in an efficient way) as follows:
1000 0000 0000: UE should include battery status
0100 0000 0000: UE should include the power consumption rate
0010 0000 0000: UE should include the heating status
0001 0000 0000: UE should include GPU/CPU utilization
0000 1000 0000: UE should include memory/storage utilization
0000 0100 0000: UE should include network capacity utilization
0000 0010 0000: UE should include active applications and their types
0000 0001 0000: UE should include AI/ML training cycles, loss function, entropy, etc. (App specific)
1111 0000 0000: UE should include the battery, power consumption, heating, and GPU/CPU utilization/availability information.
1111 1111 1111: UE should include all the above parameters in its report to NW

The above bit-mapping scheme is exemplary and can be expanded to support more bits and thus wider configurations.

The value of each pattern (i.e., each active bit) may be indicated in the form of a current absolute value or a predicted value. For example, the most significant bit in a bit stream can be linked to whether the value is predicted or not.

The NG-RAN/gNB can signal the UE to stop status reporting by sending all bits with zero value. This way, status reporting can be activated when at least one bit is active (i.e. flipped to 1).

Multiple bit-mappings can be signaled from NG-RAN (or gNB) to UE for covering more status reporting aspects (e.g., one dedicated 16 bits can be used for AI/ML aspects and another one for UE's resource status, etc.).

In an embodiment, the NG-RAN/gNB signals the status reporting configuration to the UE and also receives a status reporting from UE to support AI/ML operations. In this way, a UE may receive status reporting configuration from the NW (e.g., gNB) to support AI/ML operations over a DL RRC message (e.g., RRC Reconfiguration message or a NAS message). In a related embodiment, the UE may receive the status reporting configuration via a broadcast message (e.g., via a new Information Element (IE) in an existing System Information Block (SIB)).

The UE may send the status reporting to gNB via a new IE within an existing UL RRC message, such as UE Assistance Information, a measurement report, or a new UL RRC message, etc.

In an embodiment, means are provided by which NG-RAN/gNB gets more data/ analytics regarding the UE's status from 5GC. Here, the NG-RAN may subscribe to other Network Functions (NFs) in 5GC, such as Network Data Analytics Function (NWDAF) instances, to get more data and/or analytics regarding the UE's status/activities for this purpose. This way, 5GC may provide some data/analytics to NG-RAN (or gNB) for AI/ML services. For example, the NG-RAN may get analytics regarding UE's mobility pattern or congestion status in both CP and UP from an NWDAF instance. New analytics can be provided for AI/ML workflows with deadlines in their operations such as those in Sync-FL. Further, an NWDAF instance may get data regarding a UE indirectly from an AF e.g. Data Collection Application Function (DCAF) or an Network Exposure Function (NEF).

In an embodiment, 3GPP entities (i.e., UE, RAN, or CN) may assist to signal a UE to initiate a ProSe discovery procedure to support AI/ML operations. Here, the NG-RAN (or gNB) determines to signal a remote UE to initiate a ProSe discovery procedure (e.g., Model B) with a particular ProSe Query/App Code/RSC, which is associated with UE's ID or ProSe Service to be discovered, to discover another AI/ML-capable UE (or a set of AI/ML-capable UEs) nearby to establish a direct connection over PC5. The NG-RAN (or gNB) may interact with ProSe server to get required information (e.g., ProSe Query/App Code, RSC, etc.). It is important to note that the above determination may be performed by NG-RAN/gNB when NG-RAN/gNB predicts that a UE may not be able to complete an AI/ML operation successfully given the current condition of the UE (e.g., battery status, etc.). As part of this prediction the NG-RAN/gNB may collect data and/or analytics from 5GC and/or UE directly.

The 5GC may use an NWDAF instance to determine when a UE needs to initiate a discovery procedure. The NWDAF instance can collect required data/ statistics/analytics from UE via OAM and/or other NFs in 5GC (e.g., AF/AMF/SMF) as well as via DCAF as specified in clause 6.2.8 of TS 23.288. The results of NWDAF may be pushed to UE via SMF through SM Signalling (via NAS) or NG-RAN via AMF with the NIN2Message Transfer procedure. Alternatively, the results of NWDAF can be provided to the UE via application layer signalling, namely using the DCAF framework but in reverse order (i.e. from NWDAF towards the UE).

The determination of when a UE needs to initiate a discovery procedure can be performed by a 5GC entity other than the NWDAF. However, NWDAF can still provide relative proximity analytics, to assist with the selection the UEs. Relative proximity analytics contain statistics and predictions on so-called UE proximity attributes such as distance between UEs, relative velocity and average speed, orientation, or trajectory. The 5GC entity can use this information and make a more informed decision on which UEs to select for their AI/ML operations.

The 5GC may determine that a cluster of UEs may be better off working collaboratively with one another rather than individually with the central FL server to complete their AI/ML operations. This way, both RAN and CN release a significant amount of network and computational resources. In a related case, the 5GC can instruct a set of UEs to establish a direct connection over PC5 to a particular UE nearby (e.g., sharing ProSe App Code, or Group ID, UE's ID). Alternatively, the 5GC may determine a set of UEs that should use PC5 for FL based on subscription information. The core network e.g. may get this information from the Unified Data Management (UDM) and then pass it on to the NG-RAN as part of the UE's context setup procedure. This may be in the form of a new indication or a set of indications about FL over PC5. The NG-RAN may take any of the proposals herein based on this new indication (in the UE's context) from the AMF.

The management decisions for the group of UEs collaborating via sidelink for AI/ ML related purposes is performed at an AF. However, the 5GC can still provide recommendations for the determination of the appropriate UEs that may collaborate via sidelink for AI/ML operations. For example, the NEF may provide recommendations of which UEs could collaborate via sidelink for federated learning or model split operations. In this example, NEF collects information from other 5GC NFs to provide an informed decision to the AF on the selected UEs and possibly other parameters e.g. time windows, Quality of Service (QOS), etc.

In another solution, an AF may deliver particular service information (policy) to SMF via Policy Control Function (PCF)/NEF. The SMF may then deliver it to UE, instructing UE when to initiate a ProSe discovery procedure. First, an (AI/ML) AF provides service information (policy) to PCF by invoking the Npcf_Policy Authorization_Create/Update (request/Response) service operation. As part of this service operation, the (AI/ML) AF may include application-specific parameters received from UE (e.g., related to UE state, such as battery status, etc.). PCF then checks with UDM whether UE is allowed to provide such requested services. If so, PCF updates dynamic Policy and Charging Control (PCC) rules in SMF. Finally, SMF pushes these new rules in UE via SM Signalling (i.e., NAS transport). Note that if AF is untrusted, then it delivers the service information (related policies) to PCF via NEF.

In an embodiment, 3GPP entities (i.e., UE, RAN, or CN) may assist a remote UE in selecting a nearby AI/ML-capable UE among multiple candidates after a ProSe discovery is completed. Here, the NG-RAN may provide extra information such as a list of compulsory requirements to a remote UE. This list may include information such as a discovered (AI/ML-capable) UE should not be connected to the same cell ID as the remote UE, a discovered UE should support UE-to-Network relaying, a discovered UE should support particular AI/ML operation, etc. This extra information assists a remote UE in selecting or discovering a nearby (AI/ML-capable) UE according to the NG-RAN requirements/policy. This way, the NG-RAN/gNB triggers a ProSe discovery at a remote UE with some guidance on how a nearby UE should be filtered/discovered or selected.

A note should be taken that during a ProSe discovery, a remote UE may discover multiple candidate UEs to establish a direct connection over PC5. Therefore, under such circumstances, these requirements can also assist a remote UE in performing its peer selection according to NW preferences.

The NG-RAN/gNB may provide the above assistance information in a bit mapping format:
1000 0000: the nearby UE should support “decentralized model averaging”
0100 0000: the nearby UE should support UE-to-Network relaying
0010 0000: the nearby UE should support UE-to-UE relaying
0001 0000: the nearby UE should connected to different cell ID (BS)
0000 1000: the nearby UE should support Satellite access
0000 0100: the nearby UE should support GPU
Etc.

The NG-RAN (or gNB) provides the remote UE with Layer 2/3 address information of a nearby UE. This way, the remote UE may establish a PC5 connection to a nearby UE without initiating a ProSe discovery procedure, given that all required information (e.g., Layer-2 ID) is provided by the NG-RAN (or gNB) to UE.

The NG-RAN/gNB provides a list of candidate UEs to connect to according to some criteria such as distance to the UE, battery status, tracking area, priority, etc. In one example, NG-RAN/gNB may obtain this candidate list from 5GC (e.g., from NWDAF). The UE may then trigger a ProSe discovery procedure based on this list or establish a D2D connection to a best-suited candidate accordingly.

A UE may ask NW (e.g., NG-RAN/gNB or 5GC) for further data/analytics for its discovered UEs in order to be able to perform a suitable peer selection. For example, a UE may provide a list of discovered UE IDs to 5GC (e.g., AMF) over a NAS message to request some further data/analytics from NWDAF instances. For example, these data/analytics could be related to their mobility patterns and/or the stability of their cellular connections.

A UE may provide a list of discovered UEs to NG-RAN/gNB or 5GC and request recommendations on which UEs to select. This way, NW can perform peer selection for a UE. The NW will then inform the UE with selections or recommendations. The UE can then establish a PC5 connection to selected UEs accordingly.

A UE may ask for some data/analytics from its nearby UEs during or after a ProSe discovery procedure to ensure that its connectivity over PC5 lasts long and is stable.

This is especially crucial in scenarios where a remote UE is required to interact with AI/ML servers hosted in a cloud indirectly (i.e., this is the case where the nearby UE supports UE-to-Network Relay functionality). If a remote UE offloads its AI/ML operations completely to a nearby (AI/ML-capable) UE, then even if its PC5 connection to a nearby UE becomes intermittent or disconnected, that would not disturb the AI/ ML operations as a nearby UE can continue the ongoing AI/ML operations. Note that the AI/ML operation may need to be uniquely identifiable by the AI/ML server so that if a UE offload an AI/ML operation to another UE, the AI/ML server can detect the outcome of the operation and be able to associate it with its original UE. For example, UE Z may indicate to an AI/ML server that the outcomes of operation Q are done on behalf of UE X.

In an embodiment, 3GPP entities (i.e., UE, RAN, or CN) can assist a UE to enter low power mode. Here, once the remote UE has established its required direct D2D connection with another UE in its proximity over the PC5 reference point, the NG-RAN/gNB may signal to a UE to enter low power mode (i.e., RRC_INACTIVE/IDLE) by initiating RRCRelease message over the Uu reference point.

The network (RAN, CN, or AI/ML server) may indicate to all UEs in a FL group the maximum time required for a response to be sent, where the maximum time may have been obtained based on reports from each UE about their resources and/or time needed to complete a task. Some UEs may require less/more time based on their resource usage e.g. if they are involved in more than one AI/ML FL group or operation. The network informs the UE about the maximum time to send the outcome of the FL.

Hence, a UE which finishes its AI/ML task before this maximum time may determine to apply e.g. power savings mode (such as but not limited to turning its access stratum functions off), or other power consumption methods, until the indicated time expires. At the expiry of this time, or just before, the UE may return to normal operations and send the necessary AI/ML related data to the AI/ML server or to the network.

Alternatively, the UE may employ an AI/ML technique to predict when it will enter into a low battery state in which it may have an issue with completing its current AI/ML operations. These analytics can be produced at a UE periodically or based on a particular event (e.g., when AI/ML training starts). Alternatively, the UE may follow a policy as to how these analytics can be generated at UE. The policy can be delivered to UE from NW (e.g., from PCF via PS signalling over NAS). This way, the UE can actively determine whether it requires to establish a direct connection to a nearby UE and also transit its RRC state to INACTIVE/IDLE far before its battery level reaches a critical level at a point where UE's ongoing operations may be disrupted. For example, the UE may send RRCRelease Request to gNB. The gNB then replies back with the RRCRelease message, which transits the UE to the INACTIVE state for cellular connection. In this way, a UE with predicted power difficulty can save energy by transiting its RRC state to INACTIVE and turning off all cellular DRBs. While a remote UE is in RRC_INACTIVE, it still can interact with AI/ML server hosted in a data network over cellular (i.e., Uu) SRBs if Small Data Transmission (SDT) technology is enabled on UE. So the UE sends data plane traffic over SRB to gNB, where it is then relayed to UPF and then forwarded to its destination in a data network.

Note that the AI/ML framework deployed at UE to predict if the UE will be in low battery mode may consider several inputs into its algorithm, such as the current state of UE's battery in percentage, ongoing processes requiring computational resources, network load, active applications, user mobility, policies delivered by the network and/ or AF (e.g., DCAF), etc. The output of the AI/ML could be a prediction of the available battery level in the next time window (e.g., 1-10 secs).

Note that in the above conditions, the UE may also determine to opt-out from further engaging in AI/ML operations by notifying AI/ML application function (AF) or a dedicated AI/ML network function (NF) responsible for handling AI/ML operations in 5GC. The UE may provide a cause value for this dropout.

In an embodiment, NG-RAN/gNB determines to move AI/ML traffic off a UE from its cellular link (Uu) to Sidelink (PC5) due to high load at Base Station (BS). Here, the NG-RAN (or gNB) determines whether a remote UE should connect to another UE in its proximity if a PC5 connection is not already established. The NG-RAN (or gNB) may make this decision because a BS that a remote UE is connected to is highly loaded/congested, and moving the AI/ML traffic off the cellular link of the remote UE may provide good headroom for other competing UEs in the same BS to get a better share of the air interface resources in UL/DL. This is important because AI/ML operations are typically bandwidth-hungry such as model transfer and they will be highly common in 5G/6G networks.

In another example, the NG-RAN (or gNB) may determine whether a remote UE should connect to another UE in its proximity if a PC5 connection is not already established if the NG-RAN (or gNB) is aware that a UE is capable of relaying (e.g., UE-to-Network Relay) and is now in the proximity of the other UEs. NG-RAN/gNB may do so by monitoring UEs in their tracking areas.

In another example, the NG-RAN (or gNB) may determine whether a remote UE should connect to another UE in its proximity if a PC5 connection is not already established, if NG-RAN/gNB detects an AIML-capable UE (e.g., capable of model averaging) is in the proximity of the remote UE.

In another example, if the number of UEs involved in an FL session is at a certain threshold/maximum, either connected to the same cell or different cells such that it is more efficient for the NG-RAN that one or more relay UE(s) handles these UEs.

In a related scenario, a cluster of (remote) UEs may connect to a single AI/ ML-capable UE nearby over Sidelink where each remote UE can continue its model training with that UE. In a scenario, these remote UEs are all connected to the same cell while in another scenario they are connected to different cells. In either scenario, remote UEs in a certain geographical area are required to discover and connect to an AI/ML-capable UE. It is possible to have multiple of such AI/ML-capable UEs in a geographical area.

The scheduler at the Medium Access Control (MAC) layer of the BS may make such determinations (e.g., whether remote UE(s) should move its AI/ML traffic off the cellular link elsewhere). This can also be performed by BS according to a policy comprising a set of thresholds corresponding to the number of active UEs, resource utilization, etc.

The NG-RAN may employ an ML technique to assist in these determinations by means of predictions (e.g., traffic load, network congestion, number of active UEs, etc.). Alternatively, the NG-RAN may get assistance from 5GC for this purpose (i.e., NWDAF).

In an embodiment, it is determined how NG-RAN/gNB can know that a flow is eligible to be moved from the cellular link when BS is highly loaded. Here, the network (5GC) may indicate to NG-RAN (or gNB) that a particular AI/ML flow related to a particular AI/ML framework or operation may support such offloading, and thus NG-RAN (or gNB) can consider those flows while scheduling resources among UEs. This indication can be signalled to NG-RAN (gNB) during the PDU session establishment procedure or PDU session modification procedure.

In a related solution, NW may receive such indication from an AF responsible for handling AI/ML operations. AF may signal to 5GC (e.g., PCF) that a particular set of AI/ML workflows can be pre-emptively moved from gNB to elsewhere.

In an embodiment, the UE is configured to offload its AI/ML operation to another UE via PC5 due to one or more of low UE power, low UE memory and low UE resources. Here, the UE may be configured, e.g. due to low UE power, low UE memory, low UE resources (which may include reduced coverage), to offload or delegate its AI/ML operation (e.g. training) to another UE via PC5 link. However, the operation may be time sensitive and, as such, it is required that the operation terminates within not more than a certain time unit T (where T may be any real number representing any unit of time e.g. minutes, seconds, etc). When a UE decides to delegate its AI/ML operation to a target UE (e.g. over the PC5 link), the UE may take any of the following actions (in any order or combination):
Indicate the time requirements for the operation e.g. by what time the operation must terminate
Indicate other levels of sensitivity e.g. whether the sensitivity is low, medium, high, where a certain level may be known (e.g. via pre-configuration) to map to certain processing requirements which may be in the form of maximum time, communication rate, memory requirements, etc
The UE may provide this indication during discovery phase or communications e.g. using application layer signalling that is sent over the PC5 link for communication

A UE may receive a request to handle an AI/ML operation (e.g. optionally from another UE via a PC5 link as described above), where the request may include requirements with respect to e.g. maximum time required to complete the operation, the required resources (e.g. memory, communication, QoS, etc), the type of AI/ML model, etc. The UE may decide/determine to accept or reject the request based on its resources (e.g. power, memory, delay for the operation to be completed, etc) in comparison to the received requirements. For example, if the UE's resources permit the operation to be completed (e.g. based on the required resources which was indicated by the requesting UE) or based on time to complete the operation, then the UE may accept and optionally initiate/accept a PC5 link for communication of the related AI/ML data. Otherwise, if the UE's resources do not permit the operation to be completed (e.g. as compared to what is required by the requesting UE), then the UE may reject the operation. Alternatively, each UE may be configured to behave or operate based on a best-effort case. Alternatively, the requesting UE may indicate best-effort, or the receiving UE may accept a request and indicate best-effort although the request required stricter requirements than best-effort. It should be noted that the use of ‘best-effort’ is meant as an example and so other (at least one) levels may be defined where each level may imply a certain set of requirements (e.g. as listed above).

In one example, the requirements with respect to e.g. maximum time required to complete the operation, the required resources (e.g. memory, communication, QoS, etc.), and/or information related to the type of AI/ML model, AI/ML model functionality and/or AI/ML operation, may be provided/sent to the UE from the CN directly (via NAS signaling/messages) and/or indirectly via NG-RAN (gNB) e.g. via system information broadcast and/or RRC signaling/messages.

In another example, the above requirements and/or information related to the AI/ML model (or model functionality, and/or other information related to the AI/ML model operation) may be used by the CN and/or the NG-RAN (i.e. sent from the CN to NG-RAN) in the selection of the UE or (a group of UEs) that meets those requirements.

In an embodiment, the UE decides on using Sidelink and/or entering into power saving mode according to the cellular connection quality. Here, the UE is on the move e.g., on the train, and its cellular connection is intermittent. On that basis, the UE may decide to disconnect its cellular connectivity over Uu and instead continue its AI/ML operations via a nearby UE over PC5, which is connected to the internet via multiple cellular providers and/or other access technologies such as Wi-Fi. Alternatively, the UE may adopt one of the procedures described herein when it loses coverage with the network such that it enters a certain state such as “no cell available” state or when it is in “limited service” state.

Additionally, the remote UE may wish to relay all its traffic (including AIML) via the nearby UE if possible. The (remote) UE may then initiate a ProSe discovery procedure (e.g., Model B), searching for a nearby UE with these desired capabilities i.e., having stable connectivity to the Internet, FL-capable, availability in processing resources, etc. Once the UE has found such a UE nearby, it can establish a direct connection over PC5.

Once the PC5 link has been established with a target UE, the remote UE may also determine to change the RRC state of its cellular connection to RRC_INACTIVE/IDLE. This is especially useful when UE's cellular connection is intermittent. The UE can only change its RRC state to INACTIVE when there are no active sessions in both DL and UL across all cellular radio bearers. Suppose there are a small amount of data that needs to be exchanged regularly across all data radio bearers. In that case, the UE may still change its RRC state from CONNECTED to INACTIVE to save battery life. If SDT technology is enabled at UE, the UE can send/receive a small amount of user plane traffic over the control plane (i.e., SRBs) as described previously. If SDT is not available at the UE, and the discovered UE supports the UE-to-Network relay, then the UE may relay its traffic via Sidelink and still change its RRC state to INACTIVE.

Note that returning from the INACTIVE state to the CONNECTED state is a fast transition that quickly permits UE to activate and deactivate its cellular connectivity over the Uu interface if needed, given that NG-RAN maintains UE context and connectivity between CN and NG-RAN is established (i.e., CN resources are not released). This way, the UE could save a significant amount of battery given that maintaining connectivity to a base station consumes a considerable amount of power due to procedures such as Radio Link Monitoring (RLM), measurements and measurement reporting, PDCCH for UL/DL scheduling of the serving cell, etc. which are triggered periodically and rapidly.

FIG. 8 illustrates UE steps required to change RRC state from CONNECTED to INACTIVE in order to save energy.

In FIG. 8, UE-1 is the discoverer; UE-2 and UE-3 are discoverees. Also shown is the NG-RAN (gNB).

The steps are described as follows:

In Step 1: NG-RAN/gNB observes that UE-1 enters a tracking area where it can discover several AI/ML-capable UEs or relay UEs. The gNB signals UE-1 to initiate a ProSe Discovery procedure (e.g., Model B).

Additionally, NG-RAN/gNB may send assistance information to UE-1, for example, a list of candidate UEs (e.g., available in UE-1 tracking area) where UE-1 can directly establish a Sidelink connection over PC5 to a nearby UE. This way, UE-1 does not require initiating a ProSe discovery procedure. NG-RAN/gNB may seek 5GC to get such assistance information (from NWDAF) about UEs in a RAN tracking area or in close proximity to UE-1.

In Step 2: gNB sends to UE-1 a DL RRC message (e.g., an RRC Reconfiguration message or a NAS message) to signal UE to initiate a ProSe discovery procedure. This message may include a new IE. The message is carried over an SRB to UE, meaning that it can be delivered even if UE-1 is in low battery mode with RRC_INACTIVE.

In Step 3: UE-1 broadcasts the Solicitation message to its nearby UEs (in this case, UE-2 and UE-3). The message may include the Message Type, ProSe Application Code or ProSe Restricted Code, security protection element, and metadata information. Within the metadata information discoverer, UE-1 may indicate some desired application requirements/capabilities, such as support for decentralized model averaging or/and relaying.

The discoverer UE (UE-1) sends the Solicitation message with the Source and Destination Layer-2 IDs. The Discoveree UE determines the Destination Layer-2 ID for signaling the reception of these messages.

In Step 4: The Discoveree UE (i.e., UE-2 and UE-3) that matches the solicitation message responds to the Discoverer UE with the Response message. The Response message may include Message Type, ProSe Response Code, security protection element, metadata information. The Application layer metadata information may be included as metadata in the Response message. This may include some information related to capabilities and/or supported functionalities that can be offered to discoverer UE such as, AI/ML operations (e.g., decentralized model averaging), AI/ML frameworks, hardware availability e.g., number of GPUs/CPUs, memory, storage, battery capacity and network capacity etc.

The Discoveree UE (i.e., UE-2 and UE-3) uses the Source Layer-2 ID of the received Solicitation message to send the Response message. The Destination Layer-2 ID is set to the Source Layer-2 ID of the received Solicitation message.

In Step 5: UE-1 determines which nearby UEs to select according to provided information in the response message, particularly within application metadata information. This is especially critical when the discoverer UE has multiple desired UEs to select. A predefined policy comprising selection criteria can be used. For example, a Discoveree UE may support decentralized model averaging but does not support traffic relaying. If UE-1 has other active traffic than AI/ML applications, then it may prefer to select a Discoveree UE supporting both functionalities so that UE-1 can deactivate its cellular connection completely if desired.

In Step 6: UE-1 establishes a direct unicast connection to UE-3 over the PC5 reference point.

In Step 7: UE-1 now checks if it can change its RRC state from CONNECTED to INACTIVE or IDLE. UE-1 may not be able to do so if UE-3 does not support traffic relaying and UE-1 has some traffic from non-AI/ML applications. In this example, UE-3 supports UE_to_Network Relay so it can relay UE-1 traffic. Note that if UE-1 only deals with AI/ML operations/traffic, then it is not essential for UE-3 to support such functionality and UE-1 deactivates its cellular connectivity.

In Step 8: UE-1 asks NG-RAN (i.e., gNB) to change the RRC state from the CONNECTED mode to the INACTIVE mode by sending an RRCReleaseRequest.

In Step 9: NG-RAN (gNB) sends an RRCRelease message to UE-1 with the required configurations to change the RRC state to the INACTIVE mode.

In Step 10: UE-1 is in RRC_INACTIVE and CM_CONNECTED, all RAN resources have been released, and UE can save significant power.

Embodiments of the invention therefore provide means to address the problems identified earlier in the application and, in particular, provide means for selectively managing AI-related data and preservice resources, especially battery life in UEs.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1.-13. (canceled)

14. A method performed by a first terminal in a wireless communication system, the method comprising:
receiving, from a base station, assistance information associated with a direct unicast connection;
transmitting, to at least one terminal, a solicitation message;
receiving, from a second terminal, a response message;
performing a direct unicast connection establishment procedure with the second terminal; and
transmitting, to the second terminal, data associated with at least one of an artificial intelligence (AI), a machine learning (ML), or a federated learning,
wherein the data is transmitted to the base station via the second terminal.

15. The method of claim 14, further comprising:
performing a radio resource control (RRC) connection release procedure with the base station; and
transmitting, to the second terminal, the data in an RRC inactive mode or an RRC idle mode.

16. The method of claim 14, further comprising:
based on at least one of information on battery capability, information on connectivity, information on a processor load, information on available memory, or information on available resource, transmitting, to the second terminal, the data.

17. The method of claim 14, further comprising:
based on the response message, identifying the second terminal among the at least one terminal,
wherein the solicitation message comprises at least one of information on a message type, information on a code associated with a proximity-based service (ProSe), information on a security protection element, or information on metadata, and
wherein a direct unicast connection comprises a sidelink connection.

18. A method performed by a second terminal in a wireless communication system, the method comprising:
receiving, from a first terminal, a solicitation message;
transmitting, to the first terminal, a response message;
performing a direct unicast connection establishment procedure with the first terminal;
receiving, from the first terminal, data associated with at least one of an artificial intelligence (AI), a machine learning (ML), or a federated learning; and
transmitting, to a base station, the data.

19. The method of claim 18, further comprising:
receiving, from the first terminal, the data in a radio resource control (RRC) inactive mode or an RRC idle mode.

20. The method of claim 18, further comprising:
based on at least one of information on battery capability, information on connectivity, information on a processor load, information on available memory, or information on available resource, receiving, from the first terminal, the data.

21. The method of claim 18,
wherein the second terminal is identified among at least one terminal based on the response message,
wherein the solicitation message comprises at least one of information on a message type, information on a code associated with a proximity-based service (ProSe), information on a security protection element, or information on metadata, and
wherein a direct unicast connection comprises a sidelink connection.

22. A first terminal in a wireless communication system, the first terminal comprising:
a transceiver; and
at least one processor coupled with the first terminal and configured to:
receive, from a base station, assistance information associated with a direct unicast connection,
transmit, to at least one terminal, a solicitation message,
receive, from a second terminal, a response message,
perform a direct unicast connection establishment procedure with the second terminal, and
transmit, to the second terminal, data associated with at least one of an artificial intelligence (AI), a machine learning (ML), or a federated learning,
wherein the data is transmitted to the base station via the second terminal.

23. The first terminal of claim 22, wherein the at least one processor is further configured to:
perform a radio resource control (RRC) connection release procedure with the base station, and
transmit, to the second terminal, the data in an RRC inactive mode or an RRC idle mode.

24. The first terminal of claim 22, wherein the at least one processor is further configured to:
based on at least one of information on battery capability, information on connectivity, information on a processor load, information on available memory, or information on available resource, transmit, to the second terminal, the data.

25. The first terminal of claim 22, wherein the at least one processor is further configured to:
based on the response message, identify the second terminal among the at least one terminal,
wherein the solicitation message comprises at least one of information on a message type, information on a code associated with a proximity-based service (ProSe), information on a security protection element, or information on metadata, and
wherein a direct unicast connection comprises a sidelink connection.

26. A second terminal in a wireless communication system, the second terminal comprising:
a transceiver; and
at least one processor coupled with the second terminal and configured to:
receive, from a first terminal, a solicitation message,
transmit, to the first terminal, a response message,
perform a direct unicast connection establishment procedure with the first terminal,
receive, from the first terminal, data associated with at least one of an artificial intelligence (AI), a machine learning (ML), or a federated learning, and
transmit, to a base station, the data.

27. The second terminal of claim 26, wherein the at least one processor is further configured to:
receive, from the first terminal, the data in a radio resource control (RRC) inactive mode or an RRC idle mode.

28. The second terminal of claim 26, wherein the at least one processor is further configured to:
based on at least one of information on battery capability, information on connectivity, information on a processor load, information on available memory, or information on available resource, receive, from the first terminal, the data.

29. The second terminal of claim 26,
wherein the second terminal is identified among at least one terminal based on the response message,
wherein the solicitation message comprises at least one of information on a message type, information on a code associated with a proximity-based service (ProSe), information on a security protection element, or information on metadata, and
wherein a direct unicast connection comprises a sidelink connection.
